(19) United States
(12) Patent Application Publication
(10) Pub. No.: US 2012/0150960 A1
(43) Pub. Date: Jun. 14, 2012

(54) Social Networking

(76) Inventor: Gargi Nalawade, San Jose, CA (US)

(21) Appl. No.: 13/324,999

(22) Filed: Dec. 13, 2011

Related U.S. Application Data
(60) Provisional application No. 61/422,642, filed on Dec. 13, 2010.
(60) Provisional application No. 61/422,644, filed on Dec. 13, 2010.
(60) Provisional application No. 61/425,068, filed on Dec. 20, 2010.

(51) Int. Cl. G06F 15/16

(52) U.S. Cl. 709/204

(57) ABSTRACT

A system incorporating techniques described in this paper includes a uniform platform across social networks that can include a mechanism to dynamically discover new connections and add to a member's social network; a dynamic, intelligent relationship management for a members social network graph; and analytics on a network to aid in understanding and handling the member's social network. A system implemented in accordance with the techniques can include a uniform social network platform, an analytics engine, a connections view engine, and an entity discovery client engine.

### CROSS-REFERENCE TO RELATED APPLICATIONS

This application claims priority to U.S. provisional Ser. Nos. 61/422,642 filed Dec. 13, 2010, entitled “Dynamic Discoverable Social Networks,” 61/422,644 filed Dec. 13, 2010, entitled “Location-based Social Networks,” 61/425,068 filed Dec. 20, 2010, entitled “Dynamic Adaptive Social Networks,” each of which is incorporated by reference.

### BACKGROUND

Social networks today typically have several problems: They are static, the social network of an individual includes one big blob of different kinds of relationships, the social network of an individual includes only known people, relationship management is non-existent, and they provide no mechanism to dynamically discover new people. In the real world, a person's networks are alive, dynamic, and ever-changing. The nature of a person's relationships is not always well-remembered, well-understood, or fully exploited. The strength of the relationships keeps changing over time and the origin and context of relationships fades over time.

The foregoing example of desirable areas of research and development that are lacking in the state of the art are intended to be illustrative and not exclusive.

### SUMMARY

A system incorporating techniques described in this paper includes a uniform platform across social networks that can include a mechanism to dynamically discover new connections and add to a members social network; a dynamic, intelligent relationship management for a member's social network graph; and analytics on a network to aid in understanding and handling the member's social network. A system implemented in accordance with the techniques can include a uniform social network platform, an analytics engine, a connections view engine, and an entity discovery client engine.

### BRIEF DESCRIPTION OF THE DRAWINGS

FIG. 1 depicts an example of a dynamic social networking system.

FIG. 2 depicts an example of a discovery client.

FIG. 3 depicts a flowchart of an example of a method for using a dynamic social network.

FIG. 4 depicts a flowchart of an example of a method for responding to a connection request in a dynamic social network.

FIG. 5 depicts a flowchart of an example of a method for researching connections.

FIG. 6 depicts a flowchart of an example of a method for managing search profiles.

FIG. 7 depicts a flowchart of an example of a post-event management method.

FIG. 8 depicts a flowchart of an example of a dynamic discoverable social networking use case.

FIG. 9 depicts a conceptual diagram of the dynamic discoverable social networking use case.

FIG. 10 depicts a flowchart of an example of a location-based social networking use case.

FIG. 11 depicts a conceptual diagram of the location-based social networking use case.

FIG. 12 depicts a flowchart of an example of a dynamic adaptive social networking use case.

FIG. 13 depicts a conceptual diagram of the dynamic adaptive social networking use case.

FIG. 14 depicts an example of a computer system on which techniques described in this paper can be implemented.

### DETAILED DESCRIPTION

Specific implementations of the invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. For the purpose of clarity, technical material that is known in the technical fields related to the invention has not been described in detail so that the invention is not unnecessarily obscured.

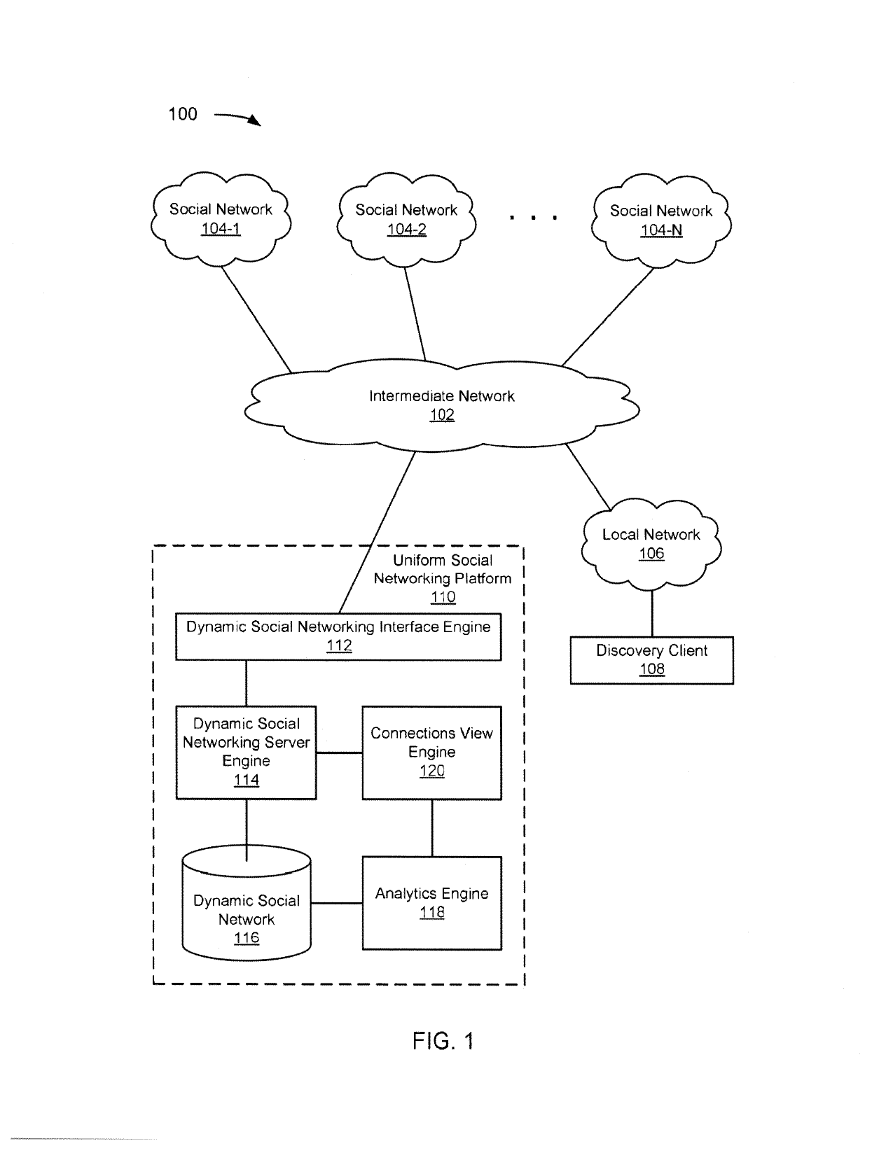

FIG. 1 depicts an example of a dynamic social networking system 100. In the example of FIG. 1, the system 100 includes an intermediate network 102, one or more social networks 104-1 to 104-N (referred to collectively as the social networks 104), a local network 106, a discovery client 108, and a uniform social networking platform 110.

In the example of FIG. 1, the intermediate network 102 is intended to include an applicable communications network such as the Internet, a public switched telephone network (PSTN), an infrastructure network (e.g., private LAN), or some other network that is capable of acting as a link between the various components depicted in FIG. 1. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (the web). A PSTN can include wired or wireless (e.g., 4G/3G/2G) network operated by, for example, a central provider. An infrastructure network that offers wireless connectivity can include wired and wireless devices in communication with wireless access points (WAPs). The wired and wireless devices can include various network equipment including by way of example but not limitation a cable network head end, a DSL network DSLAM, a fiber network aggregation node, and/or a satellite network aggregation node.

In the example of FIG. 1, the social networks 104 are coupled to the intermediate network 102. The social networks 104 can include known or convenient social networks, such as Facebook, LinkedIn, Geni, or other social network. The social networks 104 can comprise social structures operative to connect individuals, persons, or entities, by levels of interdependency. Thus, any or all of the social networks 104 can link members based on friendship, familial relationships, financial relationships, business relationships, ideological relationships or other relationships.

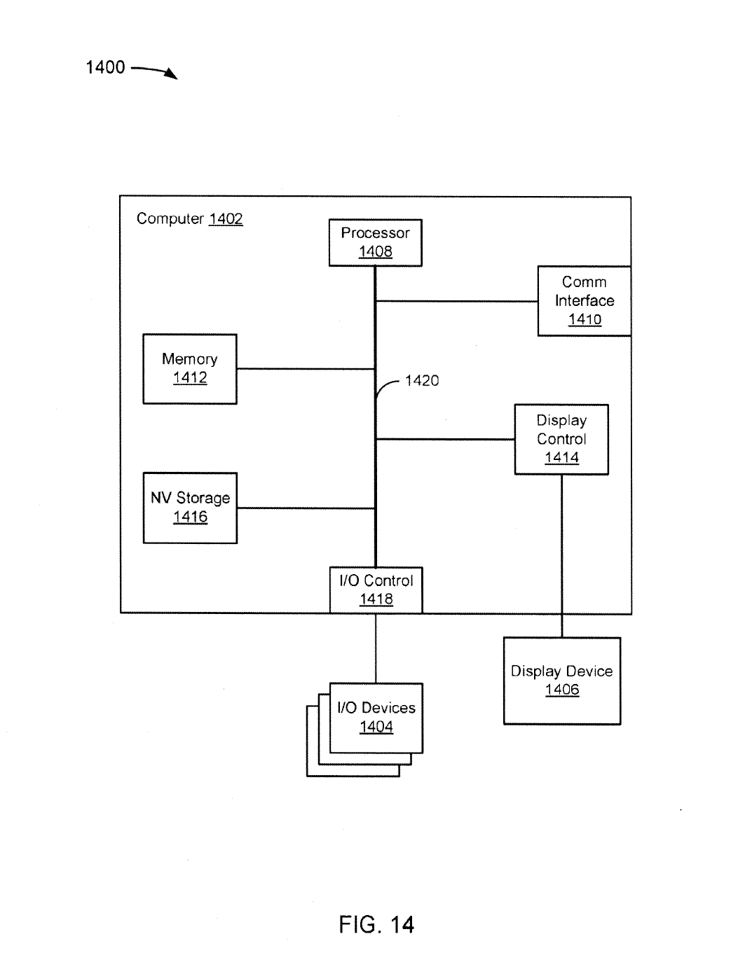

In the example of FIG. 1, the local network 106 is coupled to the intermediate network 102. The discovery client 108 is coupled to the local network 106. The local network 106 is depicted as distinct from the intermediate network 102 despite the fact that the local network 106 can be considered part of the intermediate network 102. The distinction is drawn because the discovery client 108 is described in terms of a mobile networking environment; it will often be the case that a station with the discovery client 108 will be coupled to the intermediate network 102 through a wireless network. In a specific implementation, the local network 106 includes a wireless network. In such an implementation, the discovery client 108 is implemented on a station. At a minimum, a station will include a processor, memory (though the memory could be implemented in the processor), a radio, and a radio interface (though the radio interface could be implemented as “part of” the radio). In order to make a station useful in a user device implementation, stations implemented on user devices will typically have at least one input device and at least one output device, including input and output interfaces, if applicable. A station can include components of a computer system 1400, as shown in FIG. 14.

A station can include a media access control (MAC) address and a physical layer (PHY) interface to the wireless medium that comply with, e.g., cellular standards or the IEEE 802.11 standard. A station can be described as “IEEE 802.11-compliant” when compliance with the IEEE 802.11 standard is intended to be explicit. (I.e, a device acts as described in at least a portion of the IEEE 802.11 standard.) One of ordinary skill in the relevant art would understand what the IEEE 802.11 standard comprises today and that the IEEE 802.11 standard can change over time, and would be expected to apply techniques described in this paper in compliance with future versions of the IEEE 802.11 standard if an applicable change is made. IEEE Std 802.11™-2007 (Revision of IEEE Std 802.11-1999) is incorporated by reference. IEEE 802.11k-2008, IEEE 802.11n-2009, IEEE 802.11p-2010, IEEE 802.11r-2008, IEEE 802.11w-2009, and IEEE 802.11y-2008 are also incorporated by reference. In alternative embodiments, one or more of the wireless devices may comply with some other standard or no standard at all, and may have different interfaces to a wireless or other medium. It should be noted that not all standards refer to wireless devices as “stations,” but where the term is used in this paper, it should be understood that an analogous unit will be present on all applicable wireless networks. Thus, use of the term “station” should not be construed as limiting the scope of an embodiment that describes wireless devices as stations to a standard that explicitly uses the term, unless such a limitation is appropriate in the context of the discussion.

In the example of FIG. 1, if the local network 106 includes a wireless network, the local network 106 can include an internetworking unit (IWU) that interconnects wireless devices on the local network 106 with another network, such as a wired LAN, and to the intermediate network 102. The IWU is sometimes referred to as a wireless access point (WAP). In the IEEE 802.11 standard, a WAP is also defined as a station. Thus, a station can be a non-WAP station or a WAP station. In a cellular network, the WAP is often referred to as a base station. The local network 106 can be implemented using any applicable technology, which can differ by network type or in other ways. The local network 106 can be of any appropriate size (e.g., metropolitan area network (MAN), personal area network (PAN), etc.). Broadband wireless MANs may or may not be compliant with IEEE 802.16, which is incorporated by reference. Wireless PANs may or may not be compliant with IEEE 802.15, which is incorporated by reference. The local network 106 can be identifiable by network type (e.g., 2G, 3G, WiFi), service provider, WAP/base station identifier (e.g., WiFi SSID, base station and sector ID), geographic location, or other identification criteria.

In the example of FIG. 1, the discovery client 108 is coupled to the local network 106. As has been described, the discovery client 108 can be implemented on a station. For example, the discovery client 108 can be implemented on a wireless user device such as a phone, personal data assistant (PDA), computing device, laptop, net book, tablet, camera, music/media player, GPS device, networked appliance, or some other known or convenient user device; and/or various types of intermediate networking devices. The user device may or may not be a wireless device, but the description often refers to the user device as a wireless device because it is a likely implementation in at least a subset of user cases.

In a specific implementation, the discovery client 108 can scan for and view neighbors, communicate with neighbors, make connections with neighbors, and import/download connection attributes. The discovery client 108 can be used in a variety of use cases such as, for example, searching for connections at a conference, searching for people with similar interests in a given area, match-making (dating), or searching for vendors/service-providers in a given area.

In the example of FIG. 1, the uniform social networking platform 110 includes the dynamic social networking interface engine 112, the dynamic social networking server engine 114, the dynamic social network 116, the analytics engine 118, and the connections view engine 120.

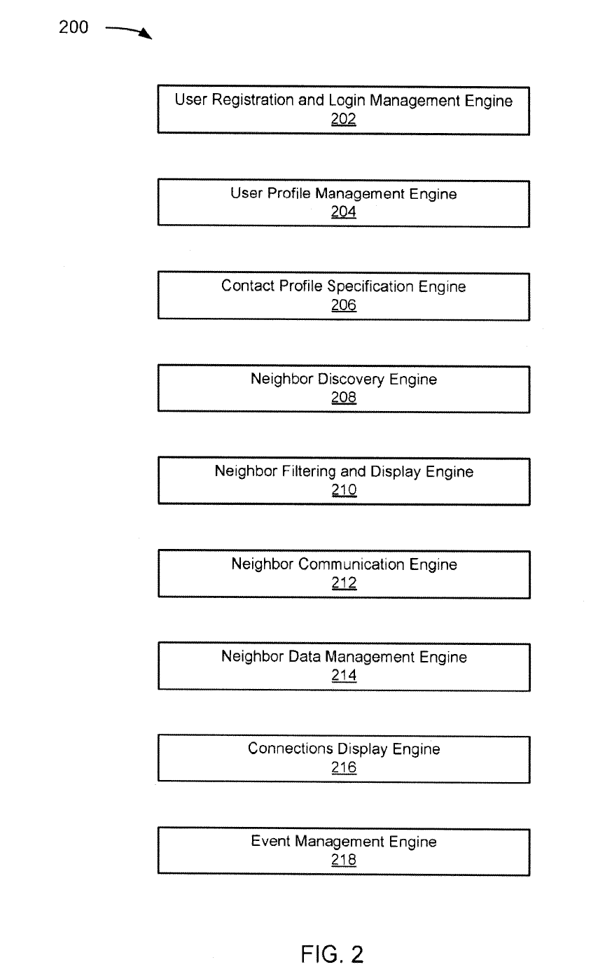

FIG. 2 depicts an example of a discovery client 200. The discovery client 200 can be implemented, for example, in a system, such as the system 100 (FIG. 1), as the discovery client 108 (FIG. 1). In the example of FIG. 2, the discovery client 200 includes a user registration and login management engine 202, a user profile management engine 204, a contact profile specification engine 206, a neighbor discovery engine 208, a neighbor filtering and display engine 210, a neighbor communication engine 212, a neighbor data management engine 214, a connections display engine 216, and an event management/discovery/clustering engine 218. As used in this paper, an engine includes a dedicated or shared processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The user registration and login management engine 202 is intended to represent the components used to enable a user of a dynamic social network to register to become a member of the dynamic social network (if applicable) and to login to the dynamic social network (if applicable). Login management can entail the use of known or convenient techniques to ensure that a member is who they say they are, that communications between the member and a server are secure, or the like. In a specific implementation, a member can login to a website associated with the dynamic social network (e.g., even if not at a venue, in time or in space, where he/she is connected with other members). In a specific implementation, the user registration and login management engine 202 accepts or generates a userid, first and last name, email address, location (dynamically provided based on IP address, GPS location, or other technique). Typically, a user must accept a EULA or disclaimer by checking a checkbox. Alternatively or in addition, a user can register using existing social network credentials, such as LinkedIn or Facebook. The user can register by logging in with an existing account (typically by entering a userid for that social network and a password). The user registration and login management engine 202 should inform the user that social network data will be used by the uniform social networking platform, and the user should explicitly agree. The user registration and login management engine 202 can provide information, such as the number of members currently online, to members. News feeds with various login information can be implemented as blobs (the size of the blob being indicative of the number of people currently logged in, for example) or scrolling news feeds.

It is sometimes useful to gather more information than will necessarily be shared immediately. For example, a member's sex, birthday, and profile picture might be useful information in personal contexts. A member's education, current employer, past employers, recommendations, and personal website might be useful in professional contexts. Contact information can be kept private or made public (often desirable for those who want to be found).

The user profile management engine 204 is intended to represent the components used to enable a member to set preferences, provide personal data, or otherwise customize an account in association with membership in (or connection to) the dynamic social network. Profile setup can include facilitating entry of, for example, a username, user contact, email, telephone, picture, other attributes (e.g., age, gender, ethnicity, height, interests, expertise, etc.), online network site IDs/links, or the like. In a specific implementation, some entries can be inherited from other social networks. For example, user attributes can be downloaded/extracted from an online social network site. Many social networks publish publicly downloadable attributes of users and the users' connections. As a specific example, Facebook allows downloads of, e.g., age, gender, and interests; and Match allows downloads of age, gender, height, and looking for attributes. The user profile management engine 204 enables members to discover people around them that are involved in a matching activity or otherwise match a particular context (avatar) of the member. Using multiple avatars, a member can group other members based on context (e.g., activity type).

The contact profile specification engine 206 is intended to represent the components used to enable a member to set parameters related to the characteristics of potential contacts within a defined geographic location. In a specific implementation, members can also advertise one or more profile views of themselves for the purpose of enabling other members to find them. For example, members could have dating, business, activity, or other profiles that they activate simultaneously, but do not wish to be conflated. In a specific implementation, the advertised profiles can include a username, picture, user attributes, search attributes, or the like. The geographic location can be the actual location of the user or can be a “constructive” location, such as the location a user is likely to be in the near or not-so-near future. The geographic location can be set by a user or can be obtained from an IP address, a GPS input, or other way.

The neighbor discovery engine 208 is intended to represent the components that enable a member to discover potential new contacts who have the parameters set by the member and are within the particular context or universe, including for instance, the geographic location (actual, constructive, etc.) set by the member in the contact profile specification engine 206. The neighbor discovery engine 208 can also conduct neighbor discovery within a virtual context in the cloud environment. For instance, the neighbor discovery engine 208 can discover neighbors within a social networking group, such as a LinkedIn group, a Google group, a Meetup group, a Facebook group, or another type of social networking or other group. The neighbor discovery engine 208 can announce itself periodically (e.g., every minute and/or for a member-configurable period) to other neighbors. The announcement can occur when a dynamic social networking app is running. It may be desirable to limit the announcement period (e.g., to 5 minutes) to ensure that neighbor datastores for members are complete by the time the limit is reached.

The neighbor filtering and display engine 210 is intended to represent the components that filter contact candidates that match the parameters set by the member and display the filtered contacts in a manner that is useful to the member. In a specific implementation, the neighbor filtering and display engine 210 can activate zero or more contact profiles to find neighbors within a Bluetooth radius, within a Wi-Fi network, or generally within an applicable area that match the contact profile(s). In a specific implementation, different contact profiles can be organized such that a member can view the results of neighbor detection in each contact profile in different tabs. In a specific implementation, if no contact profile is active the member can see all neighbors within the applicable area.

The neighbor communication engine 212 is intended to represent the components that enable a member to communicate with an identified contact. Depending upon the implementation and/or configuration, a member can communicate using a known or convenient channel (e.g., chat, text, email, phone, etc.). When a member identifies a neighbor of interest, the member can ping the neighbor to request that the neighbor become a connection. In a specific implementation, the ping request includes contact information of the member. When a member receives a ping request for connection, the member can decide to ignore, respond by accepting the connection request to add the neighbor to the member's social network, or respond by asking for more time (e.g., to get to know the neighbor) and placing the neighbor in a pending state. In a specific implementation, the ping requests for connection age and expire after a default or configurable period of time. In a specific implementation, there is a tab for viewing pending ping requests.

When a member receives contact information from neighbors, the member can download the contact information into an address book or other datastore and put (or have automatically added) a name of an application and a timestamp in association with the entry. Depending upon the implementation and/or configuration, the member can open a chat tab with the neighbor, or call or email the neighbor using the contact information provided by the neighbor.

The neighbor data management engine 214 is intended to represent the components that enable a member to manage neighbors and contacts in a meaningful way. The neighbors may be past or future “neighbors” in instances where the member is not an identified venue, in time or in space. The member can pre-process neighbors who will be at a future venue, or post-process results of interactions at the venue. In a specific implementation, the member can also scout for new connections at the venue or around a current location. The neighbor data management functionality is described in more detail later.

The connections display engine 216 is intended to represent the components that enable a member to view connections within his or her social network in a meaningful way. The connections display functionality is described in more detail later.

In the example of FIG. 2, the event management engine 218 clusters similar events together, recommends relevant event clusters and/or events to a user based on the user's interests, relevance, latest activities. The event management engine 218 can also manage discovery and clustering. The event management engine 218 can further recommend relevant events or event clusters to a user based on the user's latest activity or the activities of other self-similar users.

It may or may not be necessary to rely upon a server-side discovery agent for certain data and functionality. For example, a server-side agent may be necessary to provide effective neighbor data management, provide data derived from an analytics engine (e.g., activity factor, relationships strength, connectivity graphs, etc.), and/or integrate with online social networks (e.g., LinkedIn, Facebook, Geni, etc.).

Referring once again to the example of FIG. 1, the uniform social networking platform 110 is coupled to the intermediate network 102. The uniform social networking platform 110 includes a dynamic social networking interface engine 112, a dynamic social networking server engine 114, a dynamic social network datastore 116, and analytics engine 118, and a connections view engine 120. A web site associated with the uniform social networking platform 110 can include such things as information about the company providing the dynamic social networking services, information about the product/platform, press releases, white papers, a user section regarding use of the product/platform (e.g., a superset of what a discovery client contains), and/or other data. Post-login, the user section may or may not further include a connections view pane, a profile view pane, an upcoming conference/event update pane, and a discovery client.

In the example of FIG. 1, the dynamic social networking interface engine 112 can include a number of interfaces and associated drivers, hardware ports, etc. sufficient to enable communication with devices over the intermediate network 102. Of particular relevance for the example of FIG. 1, the dynamic social networking interface engine 112 enables communication with the social networks 104 and the discovery client 108. Thus, in the example of FIG. 1, the dynamic social networking interface engine 112 can supply information of a dynamic social network, including relevant datastores and functions, to the intermediate network 102.

In the example of FIG. 1, the dynamic social networking server engine 114 is coupled to the dynamic social networking interface engine 112. The dynamic social networking engine 114 makes services available to members of the dynamic social network. The services can include, for example, a communication layer with a user application, a distributed cache for co-located members, a member's social network graph, searching and matching engines, a connections view, dynamic grouping, and an analytics engine. In a specific implementation, the dynamic social networking server engine 114 can offer web services (e.g., through a web site).

In a specific implementation, the dynamic social networking server engine 114 can use a virtual context sent by members to create dynamic groups of users, send feeds of geo-proximal neighbor information to a member, talk to social network sites and get bulk data, and run analytics on a member's in-datastore and other social network information and activities. In a specific implementation, the virtual context can include a geo-location sent by members to create dynamic groups of users, send feeds of geo-proximal neighbor information to a member, talk to social network sites and get bulk data, and run analytics on a member's in-datastore and other social network information and activities. The virtual context can also include various universes or contexts including virtual groups such as virtual groups in the cloud. For example, the virtual context can include a LinkedIn group, a Google group, a Meetup group, other social networking group, or other group.

The services are described in more detail below. In a specific implementation, the dynamic social networking server engine 114 can use context information, such as a user's interests, sent by members to create dynamic groups of users, send feeds of interest-proximal neighbor information to a member, talk to social network sites and get bulk data, and run analytics on a member's in-datastore and other social network information and activities. In a specific implementation, the dynamic social networking server engine 114 can use event information, such as an event at which a user is present, sent by members to create dynamic groups of users, send feeds of event-proximal neighbor information to a member, talk to social network sites and get bulk data, and run analytics on a member's in-datastore and other social network information and activities. Combinations of geo-spatial data, context information, and event information data are possible.

In the example of FIG. 1, the dynamic social network datastore 116 is coupled to the dynamic social networking engine 114. A datastore can be implemented, for example, as software embodied in a physical computer-readable medium on a general- or specific-purpose machine, in firmware, in hardware, in a combination thereof, or in an applicable known or convenient device or system. Datastores in this paper are intended to include any organization of data, including tables, comma-separated values (CSV) files, traditional databases (e.g., SQL), or other applicable known or convenient organizational formats. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure.

The dynamic social network datastore 116 includes data associated with a member sufficient to enable the services described in this paper. Additional data about a member can also be stored (e.g., username and password, billing information, etc.), but this paper focuses primarily on the data structures that are useful for implementing the techniques described in detail below. The dynamic social network datastore 116 includes data structures associated with new connections discovered by the discovery client 108; attributes imported from other social networks such as Facebook, LinkedIn, Twitter, etc.; attributes imported from mashups such as OSC, Google OpenSocial, etc.; and tags added to connections, such as geo, event, context, etc.

In the example of FIG. 1, the analytics engine 118 is coupled to the dynamic social network datastore 116. The analytics engine 118 performs analytics on data in the dynamic social network 116 to facilitate providing the indicated information do members of the dynamic social network. The analytics engine 118 can calculate values such as, for example, an activity factor of a relationship, a strength of a relationship, an importance of a relationship, best-paths (active/strong/important) to an entity a few degrees away from the member, and dynamic groupings of relationships based on clusters of similarity.

In the example of FIG. 1, the connections view engine 120 is coupled to the dynamic social networking server engine 114 and the analytics engine 118. The connections view engine 120 creates the views form members to present connections in dynamic groupings. The connections view engine 120 can generate dynamic views of connections such as, for example, geographic clusters, event-based clusters, time-based clusters, nature of relationship-based clusters, interest-based clusters, and user-defined criteria clusters.

In a specific implementation, the dynamic social networking server engine 114 uses connection entries in the dynamic social network datastore 116, analytics provided by the analytics engine 118, and data from the connections view engine 120 to apply analytics and provide useful information to members. For example, a landing page for a member could include a news feed containing statistical analytics and details about most recent connections made at, e.g., an event. This can include pulling data from the social networks of other members if they have shared social network IDs. As another example, a drop down list of most recent events could be made available to members, enabling the members to click on events to display news feeds for connections made at the events. These folders could be auto-created based on events the member has attended. As another example, a drop-down list of upcoming events could be made available to members. Tabs or panes that may be of interest to a user include a connections view tab/pane, a profile view tab/pane, a neighbor discovery tab/pane, or an upcoming conference/event update tab/pane.

A connections view pane could include context “bubbles.” Connections could be viewed based upon topic, user, geo-cluster, event cluster, time cluster, interest cluster, location cluster (e.g., city), etc. Because entries in the dynamic social network datastore 116 include such values as timestamp and location where a contact is made, it becomes possible to provide a graphical representation of dynamic views of connections. Clicking on a bubble could explode the bubble into a more granular graph, display the connections table of the connections in the dynamically calculated cluster, or the like. The connections view of the connections can include statistical analysis and information about the connection. A connection profile view can include a number of fields that may vary somewhat based on implementation and/or preference. Such fields can include:

1. First Name

2. Last Name

3. Location

4. Gender

5. Picture

6. Age/Birthday

7. Current/Last-known GPS Location (note there may be a need to negotiate privacy issues)

8. Geo-tag (where the user made this connection)

9. Event-tag (Event at which the user made this connection)

10. Time-tag (When the user made this connection)

11. Interests

12. Contact Details: Phone, Email, Chat Ids, Social Network Ids

13. Rating (User-entered)

14. Comments (User-Entered)

15. Connection's Search Profile at the time the connection was made

16. Connection's current Search Profile

17. LinkedIn Inherited/Calculated Attributes:
a) Degrees of Connection away
b) Number of common Connections
c) Total Number of Connections the Connection has
d) Activity Factor on LinkedIn
e) Current Position
f) Current company
g) Recommendations: given, rcvd

18. Facebook Inherited Attributes:
a) Number of common Friends
b) Total Number of Friends
c) Activity factor on Facebook

19. Twitter Inherited Attributes:

20. Other Social Network Inherited Attributes

21. General Calculated Attributes:
a) Activity Factor of Relationship with Connection
b) Strength of Relationship with Connection
c) Importance of Relationship with Connection

The profile of a user can include the following attributes:

1. User-Id (Unchangeable)

2. First Name

3. Last Name

4. Age/Birthday

5. Gender

6. Location

7. Contact details: Phone, Email, Chat Ids, Social Network Ids

8. Search-Profiles: (1 or more)
a) I am (Keywords that describe the user)
b) Looking For (Keywords that describe who the user is searching for)

9. Current/Last-known GPS Location

An upcoming events pane can include a news feed about upcoming events in which the member has expressed or is predicted to have interest. The events could include suggested events resulting form a web search using the member's search profile keywords, user-entered events, or the like. Clicking on an event can display the relevant pane or related events (e.g., “You may also be interested in . . . ”). In a specific implementation, a website associated with an event can be linked and information can be provided therefrom (e.g., early-bird registration deadlines, to name one).

Advantageously, the uniform social networking platform can enable a member to organize conferences or other activities, including organizing by pre-conference, in-conference, and post-conference. Pre-conference can include such information as venue (e.g., driving directions), talks, chair, attendees (members can contact attendees beforehand, post questions/answers to queries, schedule meetings, etc.). In-conference can include recent connections, links to context-specific cover page. Post-conference can include list of connections made during the conference, a mechanism to review the connections made (post conference flow chart), list of other possible entities that the member could have connected based on context, and notes/reviews of the conference. Additional information could include connections made during the conference (e.g., the list of new members with which the member formed a connection, news feed from conference, tweets related to the conference, feedback for the conference (could be provided to the conference coordinators). Events can be given their own page within the dynamic social network, and members can search for and find the page (perhaps then selecting “add to my conferences.”

Advantageously, the uniform social networking platform can enable a member to categorize friends intelligently. For example, friends could be displayed as a complete list, as a manual list categorized by the member, as dynamic lists organized by the dynamic social network, or as friends from different social networks (e.g., Facebook, LinkedIn, Orkut, etc.).

A discovery algorithm can be implemented that enables a member to provide an “I am . . . ” entry and a “Looking for . . . ” entry for each context (avatar). Based on this information and a geo-location, the dynamic social network platform can find entities that are nearby and, for example, provide an instant messaging link where a member can contact an entity, a custom message that a user can send while connecting to the entity, or a checkbox to send basic user information to the entity. If a member does not specific a search profile, the member can go into “stalking mode” and be presented with profile information provided by other members.

Tabs/panels of interest can include a search bar to search the dynamic social network to find conferences, events, other members, etc.; an upcoming conferences/event information panel, friend suggestions, user statistics (e.g., stats on a new connection, socializing factor, etc.), ads, feedback, connect by LinkedIn/Facebook (e.g., connect social network accounts to import information); common tab with all news feeds; user-defined tab (e.g., conference tabs); new connections; news feed of friends.

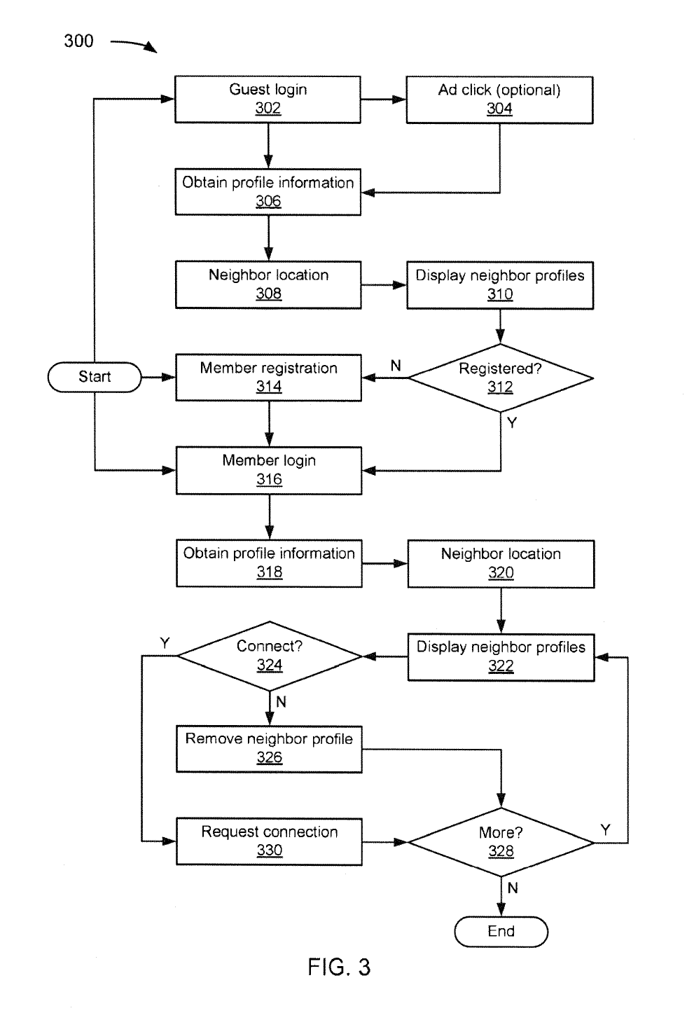

FIG. 3 depicts a flowchart 300 of an example of a method for using a dynamic social network. The example of FIG. 3 is intended to illustrate how a user can use neighbor discovery to find contacts for their social network who they potentially do not know. The flowchart 300, and other flowcharts in this paper, are illustrated as serially arranged modules and decision points, but it should be noted that the flowcharts could be reordered or arranged for parallel execution of certain modules.

In the example of FIG. 3, the flowchart 300 starts at module 302 with executing a guest login. In an implementation in which a user accesses a dynamic social network using a mobile device, the guest login can be accomplished through an app that is running on the mobile device or through a web site if the mobile device is web-enabled. While there are interesting scenarios in which a mobile device is used, it may be noted that there is no particular reason why a user could not login through a wired connection on a desktop computer. Indeed, if the user is checking a future event, the current location of the user is not particularly relevant anyway (the user's location at the future event is what matters). It is assumed for the sake of this example that any user, including registered members, could opt to login as a guest.

In the example of FIG. 3, the flowchart 300 continues to module 304 with registering an ad click. Depending upon the implementation, the dynamic social network could support operations through banner or other ads that a guest can click. The ads can be placed such that a guest can choose whether to click on them, or they can be put in the way of a guest, who must click through to continue. In any case, ads are not the only revenue model that can be implemented, making module 304 optional.

It may be noted that ads can be displayed at various points in the flowchart 300, but this is not illustrated to avoid obscuring the flow. For example, an ad could be displayed along with neighbor profiles (see module 310 below) or before neighbor profiles are displayed (e.g., after module 306, below), and clicking the ad could take the guest away from the neighbor profiles display for a time. Ads can also be displayed for members (e.g., after member login 316, after obtaining profile information 318, when neighbor profiles are displayed 322, etc.).

In the example of FIG. 3, the flowchart 300 continues to module 306 with obtaining profile information. In a specific implementation, a guest might be able to see all neighbors in a particular geographic area. However, it may be desirable to allow a guest to specify parameters for neighbors in which they are interested. In this way, the neighbors can be filtered to match the parameters specified by the guest. The manner in which the profile information is obtained from a guest is implementation-specific, but can include several fields in which data such as age, gender, profession, or the like can be entered or selected from drop-down menus, radio buttons, or other selection devices.

In the example of FIG. 3, the flowchart 300 continues to module 308 with performing neighbor location. A neighbor discovery engine can identify neighbors within a local or nearby wireless network, within a specific geographic location, within a specified radius, or the like. The neighbors can be filtered to match the specified profile parameters. It may or may not also be possible for a guest to identify future location (e.g., if an event is scheduled for some time in the future). Conceivably, some functionality could be limited to members, and not offered to guests. The neighbor discovery can also be referred to as “scouting for neighbors.”

In the example of FIG. 3, the flowchart 300 continues to module 310 with displaying neighbor profile(s). If the guest is using an app on a mobile device, the neighbor profiles can be displayed through the app, or the neighbor profiles could be displayed through, e.g., a web page. It may or may not also be possible for members to see guests in a specified location, though it is relatively unlikely that a guest will have a particularly robust profile because if the guest wished to publish their profile, they would presumably register as a member.

In the example of FIG. 3, the flowchart 300 continues to decision point 312 with determining whether the guest is registered as a member. In a specific implementation, a guest is not allowed to contact neighbors without first registering/logging in as a member of the dynamic social network. An option at this decision point is for the guest to simply quit or initiate neighbor discovery with different profile parameters, though this is not depicted in the example of FIG. 3, which assumes, for illustrative convenience, that the guest decides to proceed.

If it is determined that the guest is not a member (312-N), then the flowchart 300 continues to module 314 with performing member registration. It is also possible for a user to start at module 314 by registering for membership without ever logging in as a guest, which is represented in the example of FIG. 3 by the arrow from Start to module 314. Registration can include obtaining certain information from a user that will be kept in confidence by the owner of the dynamic social network, such as a password, credit card information, or the like. Registration will also typically include profile information that can be matched when other members attempt to discover neighbors. In a specific implementation, a member can control which profile fields are displayed for which of their avatars (e.g., a member might have a dating avatar that shares age and gender, and a business avatar that shares profession and experience). The member can also enter parameters to match a neighbor profile that the member is looking for (or the parameters can be specified at a later time).

If it is determined that the guest is a member (312-Y), or after member registration (314), the flowchart 300 continues to module 316 with performing member login. It is also possible for a user to start at module 316 by logging in as a member without ever logging in as a guest, which is represented in the example of FIG. 3 by the arrow from Start to module 316. (Typically, a user will have registered at some earlier time, or at least had an agent register on their behalf, in order to start with logging in as a member.) Generally, a user will have some control over settings, creation or modification of avatars, and the like, but for the purpose of this example, it is assumed that the purpose of logging on is to perform neighbor discovery.

In the example of FIG. 3, the flowchart 300 continues to module 318 with obtaining profile information. It may be noted that if the user initially logged in as a guest (302), then profile information may already have been obtained and used in a search. If a user logs in as a member, then the profile information can be determined from profile parameters that are either pre-entered by the member (e.g., for members who are searching for certain types of profiles each time) or entered for the purpose of an imminent neighbor discovery activity.

In the example of FIG. 3, the flowchart 300 continues to module 320 with performing neighbor location. It may be noted that if the user initially logged in as a guest (302), then neighbor locations may already have been found. Otherwise, the user device can perform neighbor discovery.

In the example of FIG. 3, the flowchart 300 continues to module 322 with displaying neighbor profile(s). It may be noted that if the user initially logged in as a guest (302), then neighbor profiles may have already been displayed; upon selecting one of the user profiles, the user could have been prompted to register (314) or login (316). Otherwise, the neighbor profiles can be displayed for the member who has the option of selecting one or more of the neighbor profiles in order to perform some operation, such as view the profile in more detail (not shown), send a connection request, or remove the neighbor from the displayed profiles (and from future searches, if applicable).

In the example of FIG. 3, the flowchart 300 continues to decision point 324 with determining whether the member wishes to connect with one of the neighbors. If it is determined that the member does not wish to connect (324-N), then the flowchart 300 continues to module 326 with removing the neighbor profile. The neighbor profile can be removed constructively by the member simply skipping over the neighbor profile. In a specific implementation, the neighbor profile can be removed without prejudice, which entails deleting the neighbor profile from the current neighbor profiles displayed. In a specific implementation, the neighbor profile can be removed with prejudice, which entails deleting the neighbor profile from the current neighbor profiles displayed and from future neighbor discovery. In any case, whether the neighbor profile is constructively removed by the member viewing and passing on the opportunity to connect or actually removed by the member, the flowchart 300 continues to decision point 328, where it is determined whether the member has more neighbor profiles to consider. If it is determined that the member has more neighbor profiles to consider (328-Y), then the flowchart 300 returns to module 322 and continues as described previously. If, on the other hand, it is determined that the member has no more neighbor profiles to consider (328-N), then the flowchart 300 ends. It may be noted that in operation, the flowchart 300 could return to one of the previous modules, such as module 318, and continue as described previously.

Returning to decision point 324, it if is determined that the member wishes to connect with one of the neighbors (324-Y), then the flowchart 300 continues to module 330 with requesting a connection. In a specific implementation, the dynamic social network can include some functionality to keep discovered neighbors anonymous by allowing neighbor profiles to be displayed without contact information. In such an implementation, the request to connect can be sent through a server of the dynamic social network to the neighbor for the neighbor to consider anonymously. In an implementation in which the neighbor profile includes contact information, such as email or phone number, the member can request a connection and contact the neighbor directly. Advantageously, a member can “friend” a contact who they would otherwise have no way of knowing.

After a connection is requested (330), depending upon the implementation, a member can be given the opportunity to withdraw a request that has not been accepted, or the request can time out after a predetermined and/or a configurable period of time (not shown). Alternatively or in addition, a member can resend a request for which a response has not been received. It may be desirable to limit the number of times a request can be resent (e.g, to one time) in order to prevent a member from asking a neighbor to connect an undesirable number of times.

In the example of FIG. 3, the flowchart 300 returns to decision point 328 and continues as described previously until all neighbors have been considered, either explicitly or constructively. Whether requests to connect result in connections depends upon the response of the neighbor.

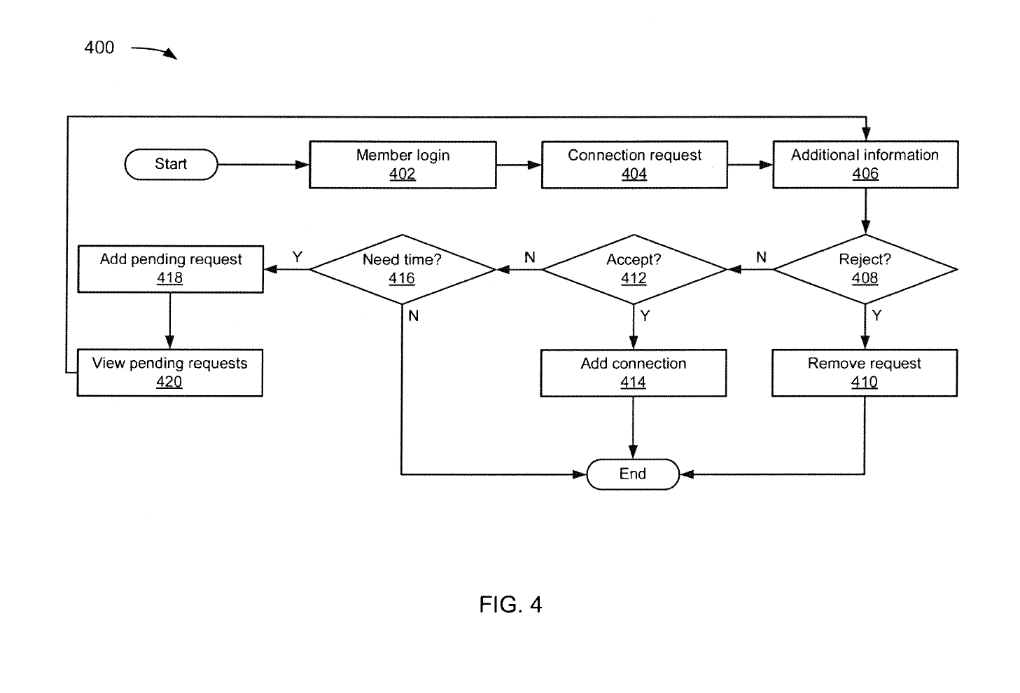

FIG. 4 depicts a flowchart 400 of an example of a method for responding to a connection request in a dynamic social network. In the example of FIG. 4, the flowchart 400 starts at module 402 with member login. In this example, it is assumed that a user must be a member in order to receive a connection request. It is possible to enable a guest to receive a connection request, but in order to take advantage of the dynamic social network management techniques described in this paper, a guest account may be deemed inadequate.

In the example of FIG. 4, the flowchart 400 continues to module 404 with receiving a connection request. In a specific implementation, the connection request is received at a dynamic social networking server and provided to a member. Alternatively, a connection request could be sent to a member directly (e.g., via email) with a link that enables the member to accept the request and add the requesting member to the receiving member's social network. Although the flowchart 400 is used to describe a single connection request, it may be noted that connection requests can be considered simultaneously. For example, the connection request could be displayed in a connection requests received display along with other connection requests.

In the example of FIG. 4, the flowchart 400 continues to module 406 with providing additional information regarding a connection request. In a specific implementation, if a member clicks on a connection request, additional information can be displayed for the connection request. For example, a pop-up window could be displayed that provides additional information about the requesting member. Alternatively or in addition (by clicking on the pop-up window), a neighbor profile view could be displayed for the member. In a specific implementation that includes a pop-up window, the pop-up window could be displayed when a cursor is on the connection request, and the pop-up window could be destroyed when the cursor moves off of the connection request (enabling the member to, e.g., move on to a next request). Additional information can include both profile information and credibility measures that are discussed elsewhere in this paper.

In the example of FIG. 4, the flowchart 400 continues to decision point 408 where it is determined whether the connection request is rejected by the member. If it is determined that the connection request is rejected by the member (408-Y), then the flowchart 400 continues to module 410 where the request is removed and the flowchart 400 ends. Of course, in operation, the member can perform other tasks following the removal of a request; the flowchart 400 ending is a logical end to the connection request process for a given connection request.

If, on the other hand, it is determined that the connection request is not rejected by the member (408-N), then the flowchart 400 continues to decision point 412 where it is determined whether the connection request is accepted by the member. The manner in which acceptance is indicated is implementation-specific, and can include clicking an acceptance link in an email, clicking an “accept” button next to the connection request in a connection request display, checking a box next to the connection request and then clicking an “accept” button, or in some other convenient manner.

If it is determined that the connection request is accepted by the member (412-Y), then the flowchart 400 continues to module 414 where the connection is added to the member's social network and the flowchart 400 ends. In a specific implementation, by accepting the connection request, the member makes profile data that is normally reserved for connections (within the context of the relevant avatar) available to the new connection. Of course, in operation, the member can perform other tasks following the removal of a request; the flowchart 400 ending is a logical end to the connection request process for a given connection request.

If, on the other hand, it is determined that the connection request is not accepted by the member (412-N), then the flowchart 400 continues to decision point 416 where it is determined whether an indication is received from the member that the member needs more time to think about connecting. In an implementation in which the connection request includes contact information, the member can choose to chat, call, correspond via email, or otherwise vet the potential contact before deciding to add the contact to the members social network. If it is determined that the member does not need more time to think about connecting (416-N), then the flowchart 400 ends. This means the member does not indicate anything about the connection request. In a specific implementation, the connection request could be automatically treated as if the member indicated they need more time to think about it. In a specific implementation, the connection request could instead be left alone, and the member could categorize the connection request as rejected, accepted, or pending at a later time.

If, on the other hand, it is determined that the member needs more time to think about connecting (416-Y), then the flowchart 400 continues to module 418 where the connection request is added as a pending request. As was mentioned above, while the request is pending, the member can either think about the connection privately, research the connection, or attempt to vet the potential connection by using contact information provided in the connection request.

In the example of FIG. 4, the flowchart 400 continues to module 420 with viewing pending requests. In a specific implementation, the pending request can be organized in a pending request tab along with other pending requests. In a specific implementation, the member can make notes about the status of the connection request and/or link correspondence to the pending request to facilitate decision-making regarding whether to add the potential connection to the member's social network.

In the example of FIG. 4, the flowchart 400 returns to module 406 and continues as described previously. Eventually, presumably, the connection request is either removed (410) or accepted and the requesting member is added to the accepting member's social network (414). The flowchart 400 can be logically applied to each connection request received by a member (potentially without repeating a member login for each connection request) and pending connection requests can be viewed by the member as a group (420).

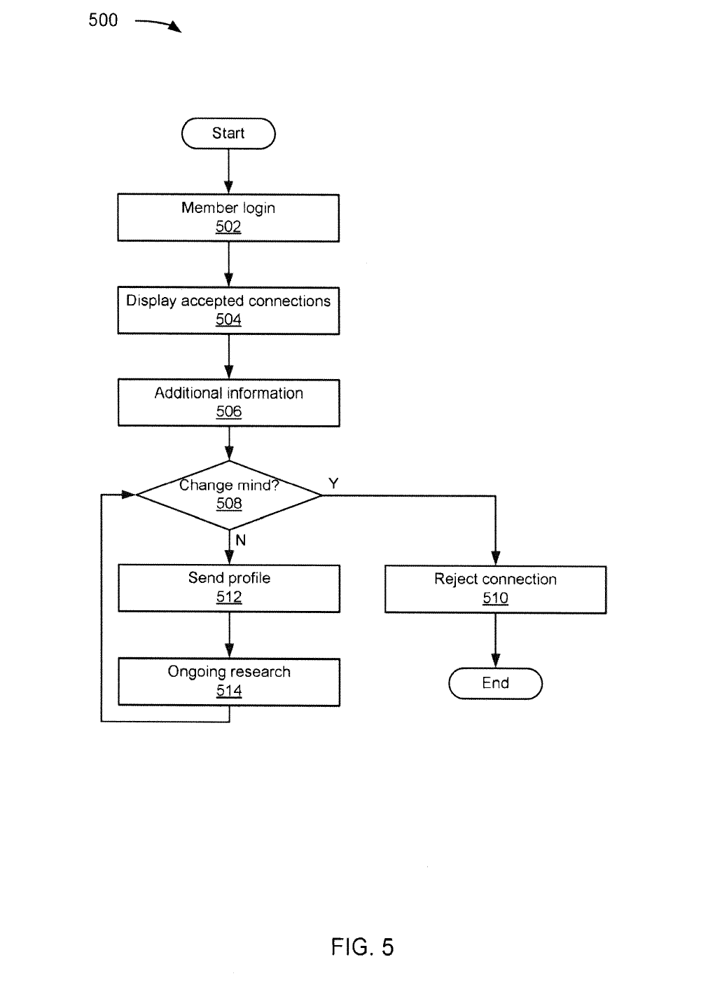

FIG. 5 depicts a flowchart of an example of a method for researching connections. In the example of FIG. 5, the flowchart 500 starts at module 502 with member login and continues to module 504 with displaying accepted connections. To reach the accepted connections display, a member will typically be required to select an accepted connections tab, though the display could also be a default when connections have been accepted, but research has not yet been conducted.

In the example of FIG. 5, the flowchart 500 continues to module 506 where the member is provided additional information about the new connection. The additional information can be from profile information about the accepted connection that is made available after a connection is accepted, comments from other members who are currently or were formerly connected to the new connection, information received directly from the new connection, perhaps after meeting personally or through correspondence.

In the example of FIG. 5, the flowchart 500 continues to decision point 508 where it is determined whether the member has changed his or her mind about the accepted connection. If an indication is received from the member that the member has changed his or her mind (508-Y), then the flowchart 500 continues to module 510 with rejecting the connection. If the connection is rejected then the connection is removed from the member's social network and profile information that is reserved for connections is no longer available to the member (and the member's profile information is no longer available to the new connection).

If, on the other hand, it is determined that the member has not changed his or her mind about the accepted connection (508-N), then the member or the dynamic social network server can send the member's profile to the new connection. Depending upon the implementation, it may be the case that the new connection already has the member's profile (e.g., the profile could be made available upon acceptance of the new connection or before additional information was requested at module 506).

In the example of FIG. 5, the flowchart 500 continues to module 514 with providing information related to ongoing research of the connection. Much as a neighbor can be researched, the member can continue to research connections. Data associated with a connection, such as number of friends, strength of contacts, number of acceptances, etc. can change over time, and the data may impact the member's decision regarding whether to maintain a connection. Connections can be researched in the same way other neighbors can be (e.g., with a pop-up window that provides additional data about a connection). Thus, the vetting of connections need not ever completely go away. Accordingly, the flowchart 500 returns to decision point 508 and continues as described previously, looping indefinitely until the connection is rejected (510), if ever.

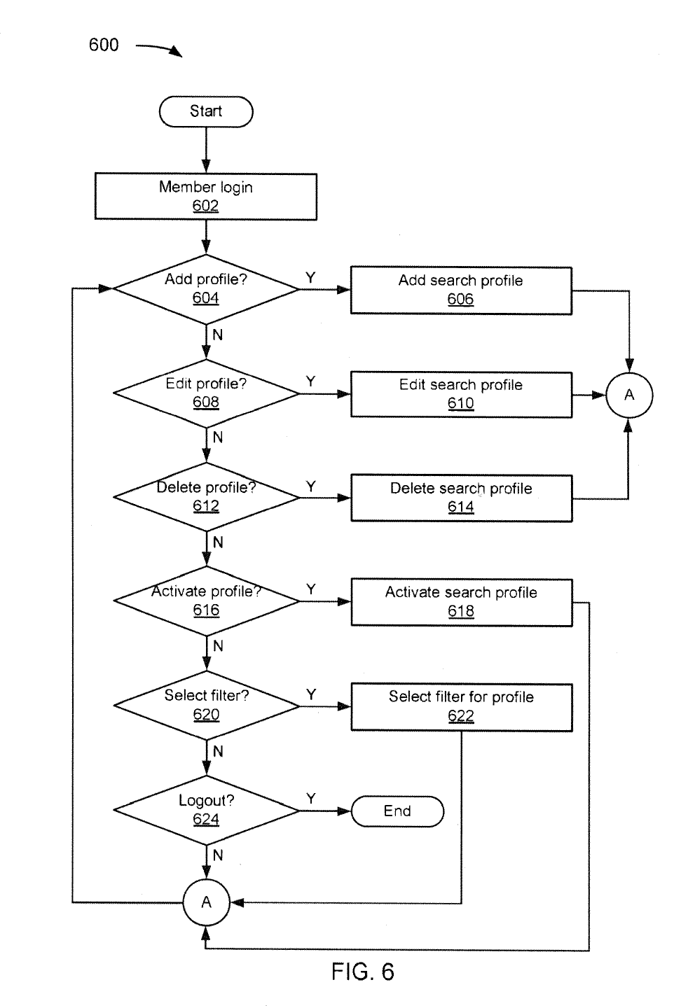

FIG. 6 depicts a flowchart 600 of an example of a method for managing search profiles. In the example of FIG. 6, the flowchart 600 starts at module 602 with member login and continues to decision point 604 where it is determined whether a member has indicated a search profile is to be added. If it is determined that a search profile is to be added (604-Y), then the flowchart 600 continues to module 606 where the search profile is added to the relevant context (avatar) of the member, and the flowchart 600 returns to decision point 604.

If, on the other hand, it is determined that a search profile is not to be added (604-N), then the flowchart 600 continues to decision point 608 where it is determined whether a search profile is to be edited. If it is determined that a search profile is to be edited (608-Y), then the flowchart 600 continues to module 610 where an existing search profile is edited for a relevant context (avatar) of the member, and the flowchart 600 returns to decision point 604. The existing search profile can be made particular for a given universe, event, or context. That is, the search profile can be modified to include data customized for or specific to the given universe, event, or context.

If, on the other hand, it is determined that a search profile is not to be edited (608-N), then the flowchart 600 continues to decision point 612 where it is determined whether a search profile is to be deleted. If it is determined that a search profile is to be deleted (612-Y), then the flowchart 600 continues to module 614 where an existing search profile is deleted and the flowchart 600 returns to decision point 604.

If, on the other hand, it is determined that a search profile is not to be deleted (612-N), then the flowchart 600 continues to decision point 616 where it is determined whether a search profile is to be activated. If it is determined that a search profile is to be activated (616-Y), then the flowchart 600 continues to module 618 with activating an existing search profile and the flowchart 600 returns to decision point 604. A search profile can be activated within a particular context (avatar) of the member. In a specific implementation, multiple search profiles can be activated for a single context, but for the purposes of this paper, multiple search profiles activated for a single context (avatar) are generally referred to as a single search profile, where a single search profile can include multiple search sub-profiles for a given context. As used in this paper, multiple search profiles for multiple different contexts are referred to as multiple search profiles. Depending upon the implementation, search profiles can be applicable across multiple contexts. For the purpose of this paper, a search profile that is applicable in multiple contexts is referred to as multiple search profiles that, in a specific case, are identical to one another, but applied to a different context.

If, on the other hand, it is determined that a search profile is not to be activated (616-N), then the flowchart 600 continues to decision point 620 where it is determined whether a filter is to be selected for a search profile. If it is determined that a filter is to be selected for a search profile (620-Y), then the flowchart 600 continues to module 622 where a filter is selected for an existing search profile and the flowchart 600 returns to decision point 604. In a specific implementation, a member can select a connection view filter, a request view filter, or some other filter that results in a display that is desired for a particular context.

If, on the other hand, it is determined that a filter is not to be selected for a search profile (620-N), then the flowchart 600 continues to decision point 624 where it is determined whether a logout is initiated by the member. If it is determined that a logout is initiated by the member (624-Y), then the flowchart 600 ends. If, on the other hand, it is determined that a logout has not been initiated by the member (624-N), then the flowchart 600 returns to decision point 604. Presumably the member can do something other than manage profiles if they remain logged in at this point (or do some other profile management task that is not explicitly described in this example).

Advantageously, the techniques described above with reference to FIGS. 1-6 enable a number of interesting use cases. For example, the techniques enable a user to search for connections at a conference, search for people with similar interests in a given area, search for a date (“match-making”), or search for vendors or service providers in a given area. However, the use cases are not limited to consumer use cases, and could include an enterprise virtual network to enable employees within a company to intelligently network with one another, help employees find information faster, and enable better, more efficient contextual collaboration. Mobile workers such as firemen, truckers, etc., can use the techniques in a peer-to-peer network to help go-locate coworkers, to search for coworkers with a specific skill, timeline, etc., or to enable an employer to locate workers to facilitate better routing and re-routing. As another example, the techniques could be used on behalf of a political movement to help track electorate workers, to capture, track, and analyze voter information, and to provide more efficient geo-, event-, context-based analysis and predictions. As another example, the discovery client can be used to find service providers providing specific services, such as students looking for tutors and vice versa, recruiters looking for talent and vice versa, anyone looking for a handyman, anyone looking for a store (assuming the store becomes a member).

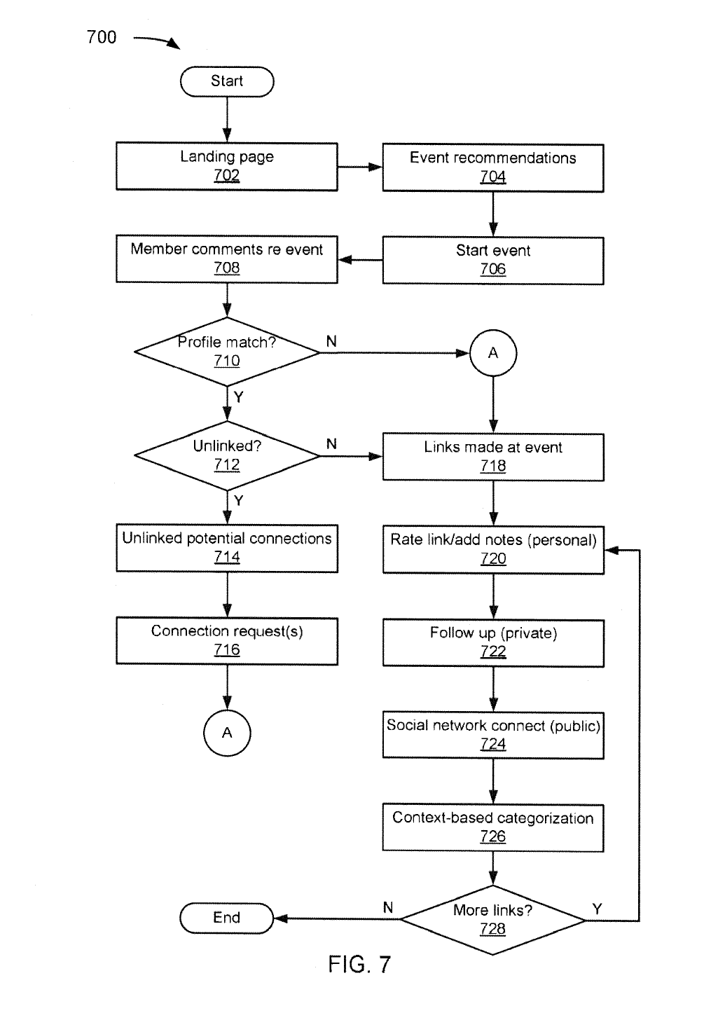

FIG. 7 depicts a flowchart of an example of a post-event management method. In the example of FIG. 7, the flowchart 700 starts at module 702 at a member landing page for a uniform social networking platform. The landing page can provide a variety of information and options to the member. Of particular interest in this example is events information.

In the example of FIG. 7, the flowchart 700 continues to module 704 with providing event recommendations to the member. Event recommendations are optional, and a uniform social networking platform could be implemented without event recommendations. However, in at least one implementation, a member can search for events of interest and also receive recommendations for events that are predicted to be of interest to the member.

In the example of FIG. 7, the flowchart 700 continues to module 706 with a start event stimulus. Typically, the start event stimulus is reaching an event start time. The location of the member may or may not be correlated to the event location by the system, and if the correlation is made it is not necessarily controlling. For example, a user could teleconference to an event and could override an actual location in favor of an event location for the purpose of tagging connections made at the event and/or advertising the member's location in the context of the event.

In the example of FIG. 7, the flowchart 700 continues to module 708 with receiving member comments regarding the event. The comments can be personal comments, reviews, or other notes about the event that the member is attending (or just attended). Personal comments can be for the member's own notes, while reviews can be made public or provided to event organizers.

In the example of FIG. 7, the flowchart 700 continues to decision point 710 with determining whether a profile match is made. If it is determined that a profile match is made (710-Y), then the flowchart 700 continues to decision point 712 where it is determined whether there are any potential contacts from the event that are unlinked. If it is determined that there are unlinked potential contacts from the event (712-Y), then the flowchart 700 continues to module 714 with listing unlinked potential connections. Because it is known that the potential connections are profile matches (710-Y), a member may find it desirable to follow up with the potential connections.

In the example of FIG. 7, the flowchart 700 continues to module 716 with making connection requests. The member can select unlinked potential contacts from the list of unlinked potential connections and send connection requests to individual ones of the unlinked potential connections or send connection requests to all of the unlinked potential connections (either by using a send all option, or selecting each of the unlinked potential connections from the list and sending a connection request to each).

In the example of FIG. 7, the flowchart 700 continues to module 718 with listing links made at the event. The listing of links made at the event can include the links that were just made, assuming connection requests were accepted (modules 714, 716). Referring back to decision points 710, 712, if it is determined that a profile match was not made (710-N) or if it is determined that there are no unlinked potential contacts from the event (712-N), then the flowchart continues to module 718 as just described.

In the example of FIG. 7, the flowchart 700 continues to module 720 with rating links and/or adding notes in association with links. Rating links and making notes can be considered personal information for use by the member. Of course, the member could also share the information, either informally or through the uniform social networking platform, if link rating sharing is implemented.

In the example of FIG. 7, the flowchart 700 continues to module 722 with facilitating a follow up. The follow up can be facilitated by providing contact information to the member from the new connection, and vice versa. Depending upon the implementation, follow up can include sending a follow-up message through the platform or through some other channel (e.g., email), sending questions, requesting information, or the like. The follow-up can be kept private between the member and the new connection. Presumably, the follow-up could include activities that are not orchestrated through the platform, such as meeting in person or speaking over the phone.

In the example of FIG. 7, the flowchart 700 continues to module 724 with establishing a social network connection. The social network connection can be in well-known social networks, such as Facebook or LinkedIn. The connection is typically made public, pursuant to the procedures of the social networks. The uniform social networking platform can also publish the connection.

In the example of FIG. 7, the flowchart 700 continues to module 726 with context-based categorization. Because the uniform social networking platform includes context-sensitive connection entries, it becomes possible to categorize connections by context. New connections can be sorted by the event, related events, time, etc.

In the example of FIG. 7, the flowchart 700 continues to decision point 728 where it is determined whether there are more links for which follow-up is desired. If there are more links (728-Y), then the flowchart 700 returns to module 720 and continues as described previously. Typically, there would be no requirement that the member follow-up with each and every link. After all of the links have been considered (728-N), if applicable, the flowchart 700 ends.

In a specific implementation that includes dynamic discoverable social networking, a social network can be adapted based upon parameters and preferences. A member can add, delete, and categorize contacts, search contacts, and make contacts based on the member's chosen parameters. This enables the member to find the right people with a desired skill set at a conference, find activity partners near home or a hotel, find potential dates wherever the member is, find like-minded people while traveling, find employees or employers, find discount deals near the member, to name several use cases. Techniques for dynamic discoverable social networking can include implementing a search algorithm in a search engine configured for a member's interests or criteria to find a matching entity (person or thing), maintenance of search profiles or search criteria for the member; a criteria matching engine to find the appropriate people or things that match the search profile or search criteria of the member; a filtering or pattern matching algorithm implementation to enable matching of search profiles to advertised parameters (e.g., using an “I am . . . ” criteria and a “Looking for . . . ” criteria) for one or more active search profiles (avatars) of the member, including ad hoc profiles or pre-existing Facebook/Twitter/LinkedIn/dating site profiles to which communications with potential connections can be linked; a mechanism for identifying and creating a network partition based on matching search criteria or the member's active or inactive profiles or criteria; a mechanism for creating and tagging searched users found and storing the found users in a network partition; a mechanism for managing one or more network partitions which can be user-configurable and/or dynamically created based on member preferences and interests.

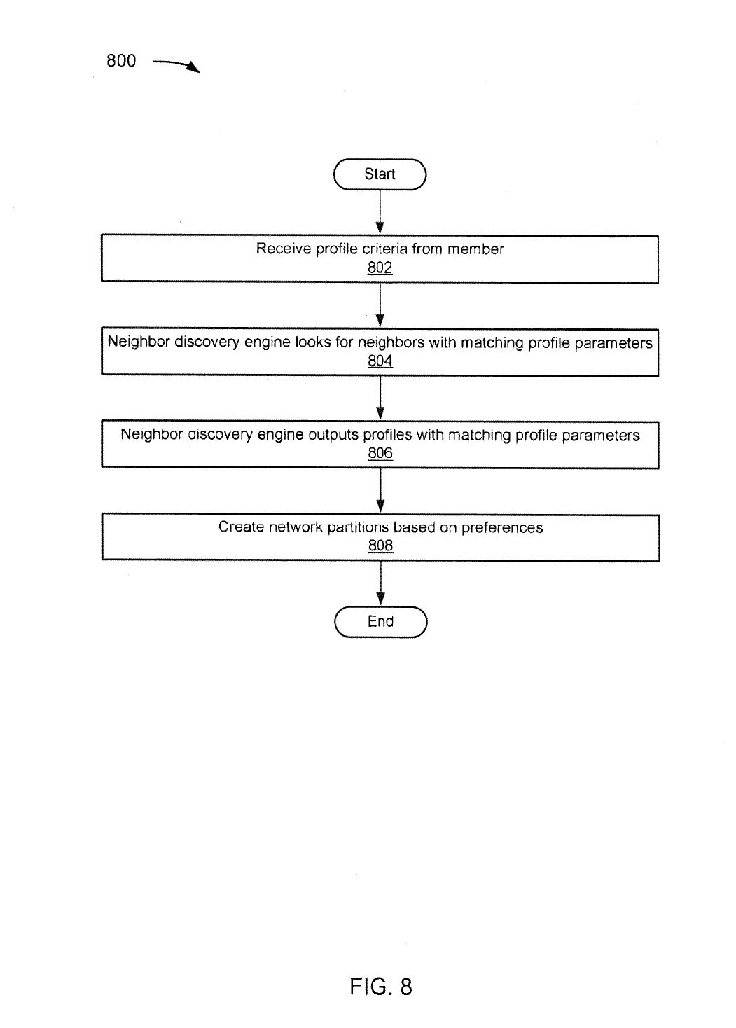

FIG. 8 depicts a flowchart 800 of an example of a dynamic discoverable social networking use case. In the example of FIG. 8, the flowchart 800 starts at module 802 with receiving profile criteria from a member. In the example of FIG. 8, the flowchart 800 continues to module 804 with a neighbor discovery engine looking for neighbors with matching profile parameters. In the example of FIG. 8, the flowchart 800 continues to module 806 with matching profile parameters. In the example of FIG. 8, the flowchart 800 continues to module 808 with creating network partitions based upon the preferences of a member. Connections made using dynamic discoverable social networking can be slotted into the appropriate network partitions. Neighbors are discoverable based on their parameters, as opposed to whether they are known to the member through some degree of separation.

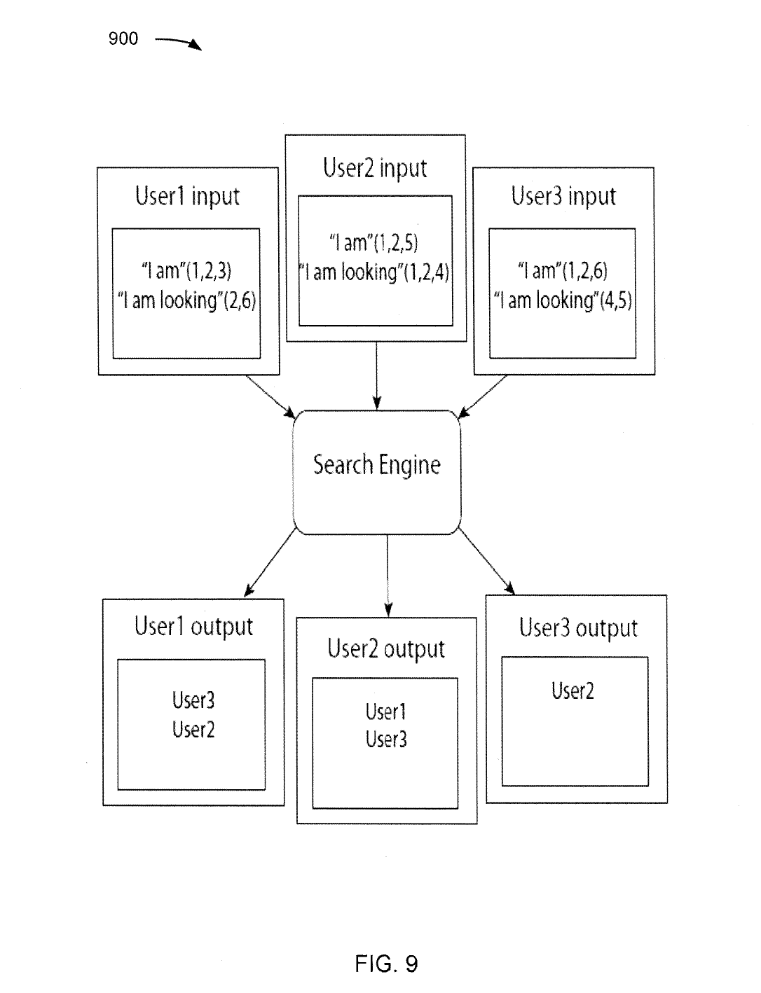

FIG. 9 depicts a conceptual diagram 900 of the dynamic discoverable social networking use case. The example of FIG. 9 shows a first input, a second input, a third input, a search engine, a first output, a second output, and a third output.

In the example of FIG. 9, a first input, User1 input, can include an indication that a first user has a first attribute, a second attribute, and a third attribute. The first input can also include an indication that the first user is looking for a user with the second attribute and the sixth attribute. In the example of FIG. 9, a second input, User2 input can include an indication that a second user has a first attribute, a second attribute, and a fifth attribute. The second input can also include an indication that the second user is looking for a user with the first attribute, the second attribute, and the fourth attribute. In the example of FIG. 9, a third input, User3 input, can include an indication that a third user has a first attribute, a second attribute, and a sixth attribute. The third input can also include an indication that the third user is looking for a user with the fourth attribute and the fifth attribute.

In the example of FIG. 9, the first input, the second input, and the third input, can be supplied to the search engine. The search engine can perform one or more search and/or matching algorithms to connect users having attributes with users seeking those attributes.

In the example of FIG. 9, a first output, User1 output, can include identifiers to connect the first user with the second user and the third user based on the first user's desired attributes. In this example, the first user is connected to the second user (based on the first user's desire for the second and sixth attributes and the second user's possession of the second attribute), and the third user (based on the first user's desire for the second and sixth attributes and the third user's possession of the second and sixth attributes). A second output, User2 output, can include identifiers to connect the second user with the first user and the third user based on the second user's desired attributes. In this example, the second user is connected to the first user (based on the second user's desire for the first and the second attributes and the first user's possession of the first and second attributes), and the third user (based on the second user's desire for the first and second attributes and the third user's possession of the first and second attributes). A third output, User3 output, can include identifiers to connect the third user with the second user based on the third user's desired attributes. In this example, the third user is connected to the second user based on the third user's desire for the fifth attribute and the second user's possession of the fifth attribute.

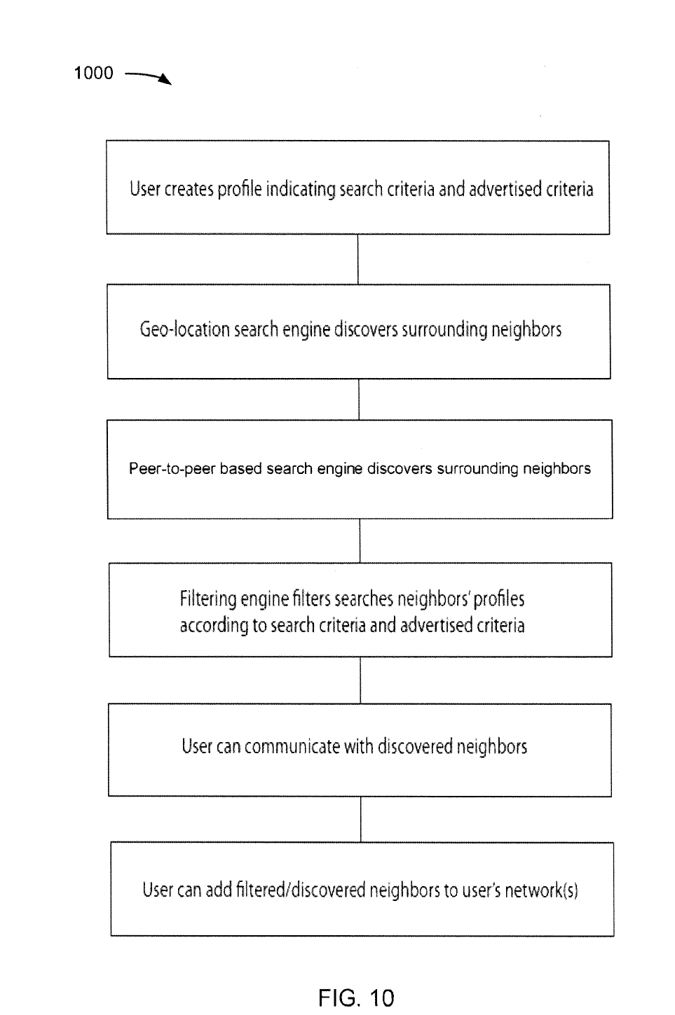

FIG. 10 depicts a flowchart 1000 of an example of a location-based social networking use case. The use case enables identification of neighboring entities that might be of interest to a member based on the member's interests or preferences. A discovery engine can identify other entities (aka neighbors) in the vicinity of a member's context. The context can be an actual location of the member or a constructive location, though in some situations, actual location can be important. The discovery engine can display neighbors and advertised criteria about the neighbors to the member. Using this information, the member can target neighbors in which the member has an interest or that might be interested in the member or an intersection of both to add to the member's social network. The member can use geo-location based matching to network with, communicate with, or add to the member's social network. The discovery engine can use peer-to-peer-based search, location-based search and/or Bluetooth-based discovery of neighbors within range. (I.e., the discovery engine could use Bluetooth, Alljoyn, NFC, or other technologies for peer-to-peer or other communications.) A filtering engine can filter neighbors based on the member's preferences or prevent users with an unwanted profile from communicating with or even detecting the member. Advantageously, the use case can include finding the right people with a desired skill set at a conference, finding activity partners near home or a hotel, finding dates near where you are, finding like-mined people when traveling, finding employees or employers, finding discount deals near the member, using geo-location and/or Bluetooth-based discovery, and creating and/or maintaining a location-based context. A system implementing techniques useful to this use case can include a geo-location based search engine to discover surrounding users (neighbors); a Bluetooth based search engine to discover surrounding users (neighbors); a filtering engine to filter users; a user profile that includes search criteria to search for other neighbors' interests/strengths/expertise, etc. or advertised parameters of the users' interests/strengths/expertise etc.; one or more such user profiles can exist simultaneously and be active or inactive at the same time; a mechanism to communicate with the discovered neighbors; a mechanism to add the filtered/discovered neighbors to the user's network(s).

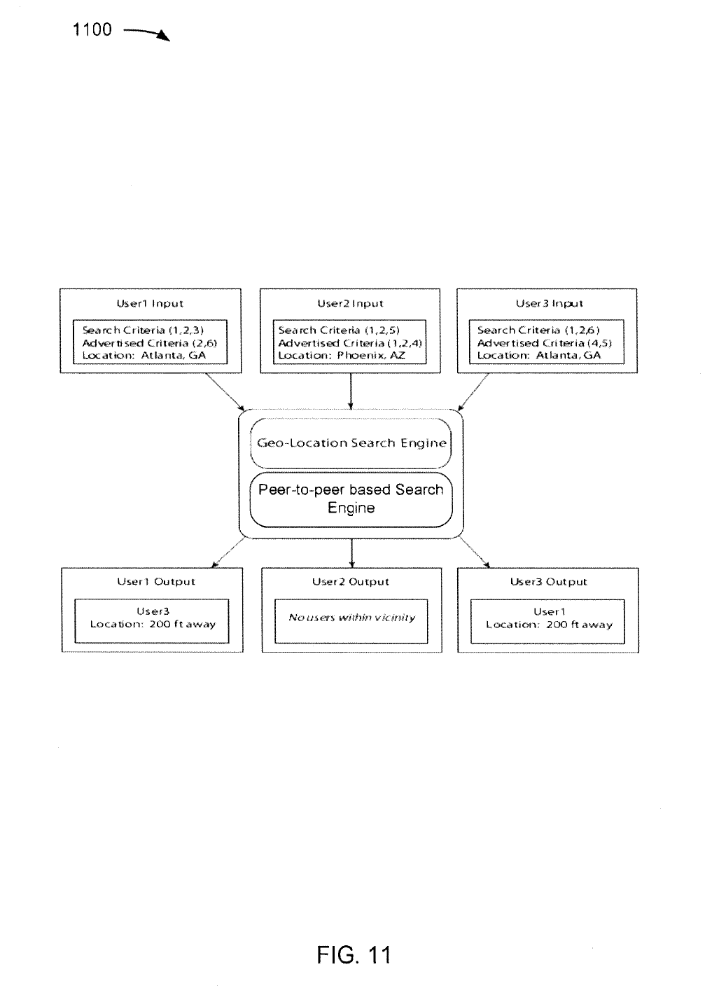

FIG. 11 depicts a conceptual diagram 1100 of the location-based social networking use case. The example of FIG. 11 shows a first input, a second input, a third input, one or more search engines, a first output, a second output, and a third output.

In the example of FIG. 11, a first input, User1 input, can include: a first search criteria (here, a criteria for a first attribute, a second attribute, and a third attribute); a first set of advertised criteria (here, a second advertising attribute and a sixth advertising attribute), and a first location (here, Atlanta, Ga.). A second input, User2 input, can include: a second search criteria (here, a criteria for the first attribute, the second attribute, and a fifth attribute); a second set of advertised criteria (here, a first advertising attribute, the second advertising attribute, and a fourth advertising attribute), and a second location (here, Phoenix, Ariz.). A third input, User3 input, can include: a third search criteria (here, a criteria for the first attribute, the second attribute, and a sixth attribute); a third set of advertised criteria (here, the fourth advertising attribute and a fifth advertising attribute), and a third location (here, Atlanta, Ga.).

In the example of FIG. 11, the first input, the second input, and the third input, can be supplied to the one or more search engines. The one or more search engines can include a geo-location search engine that searches on a geographical proximity basis, and a peer-to-peer-based search engine (such as a Bluetooth-based search engine, Alljoyn-based search engine, NFC-based search engine, or other peer-to-peer based search engine), that can connect devices based on Bluetooth frequencies and protocols.

In the example of FIG. 11, the first output, User1 output, can, based on the results of the one or more search engines, output to the first user the information of another user who matches the search and geographical proximity criteria. In the illustrated example, the first output can tell the first user that the third user is in Atlanta, Ga., and perhaps no more than 200 feet away. The third user in such a case will have attributes that match the search criteria of the first user. Similarly, a second output, User2 output, can tell a second user that no other users are proximate to the second user. A third output, User3 output, can tell the third user that the first user is within 200 feet and meets the third user's search criteria.

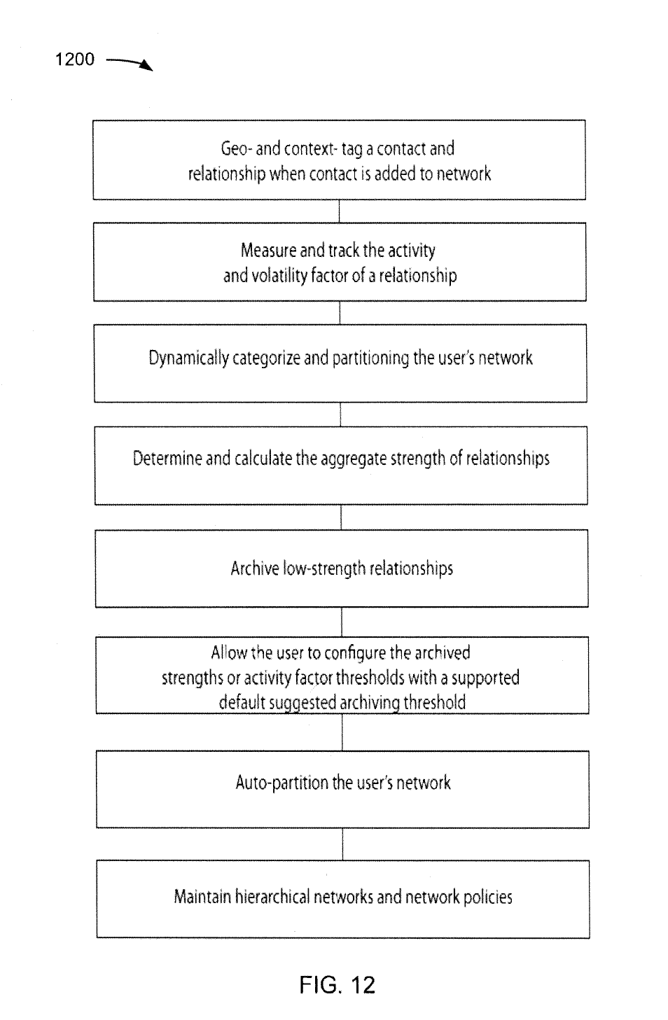

FIG. 12 depicts a flowchart 1200 of an example of a dynamic adaptive social networking use case. With dynamic adaptive social networking, a member can adapt his or her network based on real life and dynamic changes that occur in his or her life or relationships. The member can keep a better handle on his/her social networks and better classify, categorize, tag and track them. Dynamic adaptive social networking is applicable in many situations:
Knowing which are the high-impact relations the user has
Knowing which are the low-impact relations the user has and possibly archiving them
Partitioning the user's network into different views
Dynamically calculating and maintaining activity factors of the user's relationships
Geo and context tagging of the user's contacts and relations
Maintaining sales leads and information
Maintaining and finding what the strength of the relationship between your neighbor and his/her neighbor you want to get introduced to, in a secure manner, without exposing the user's private details of ties or relationships
Deciding how much to trust a reference given by a friend or your contact
Categorizing and maintaining a handle over your relationships and networks
Partitioning your network views while maintaining a common platform
Connecting with the same human person in one or more contexts and forms of relationships thus knowing the multi-dimensional aspects of your contact.

A system implementing dynamic adaptive social networking techniques can include:
1. A mechanism to geo and context tag the contact and the relationship when a contact is added to the network
2. A mechanism to measure and track the activity and volatility factor of a relationship
3. A mechanism to dynamically categorize and partition the user's network based on the tagging, activity, keywords and the preferences of the user
4. A mechanism to calculate the aggregate strength of a relationship based on factors such as geography, activity factor, history and volatility of a relationship between immediate contacts.
5. A mechanism to calculate aggregate strength of a long-distance toted relationship between 2 people who are separated through a few degrees of separation by aggregating the strengths of relationships along the way.
6. A mechanism to archive the low-strength relationships of a user
7. A mechanism for the user to configure the archiving strength or activity factor thresholds with a supported default suggested archiving thresholds
8. A mechanism for auto-partitioning a user's network
9. A mechanism for maintaining hierarchical networks and network policies

When a user adds a contact to his/her network, an engine can tag the contact, the relationship, and timestamp it. The member can create keywords and preferences for network partitioning and archiving. An analytics engine can calculate a default activity factor based on parameters such as geography, keywords, date etc. The analytics engine on an ongoing basis can keep updating the activity and strength factor of the relationships based on current activities and exchanges between the users (contacts). A mechanism can publish feeds or updates to only certain branches of a user's network and a different update to yet other branches of a user's network, depending upon context.

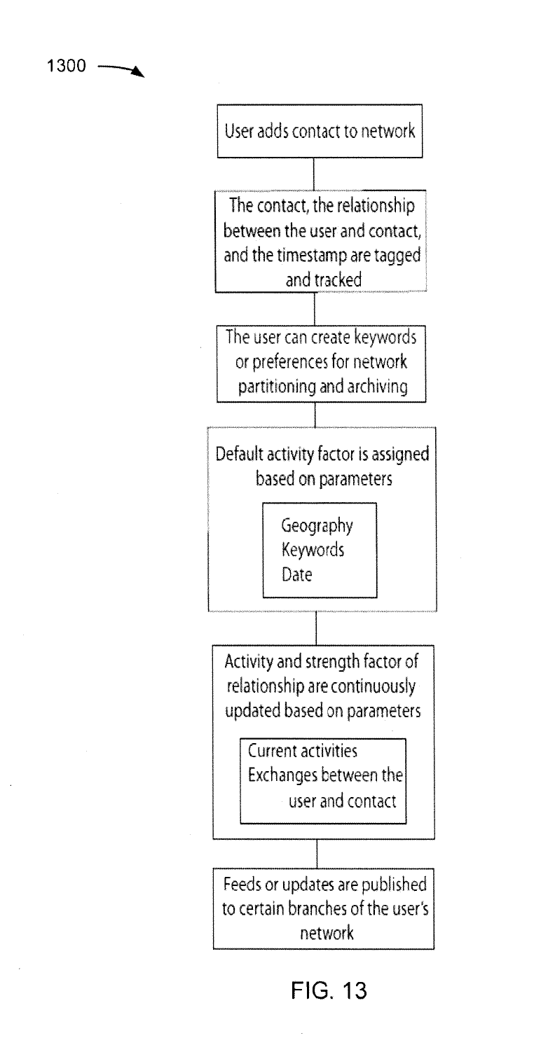

FIG. 13 depicts a conceptual diagram 1300 of the dynamic adaptive social networking use case. The example of FIG. 13 includes a module where the contact, the relationship between the user and the contact, and a timestamp are tagged and tracked. The example of FIG. 13 further includes a module where the user can create keywords or preferences for network partitioning and archiving. The example of FIG. 13 also includes a module where a default activity factor is assigned based on parameters, such as geography, keyword, and date. The example of FIG. 13 further includes a module where the activity and strength factor of a relationship are continuously updated based on parameters. Exemplary parameters include current activities, exchanges between the user and the contact, and other parameters. The example of FIG. 13 further includes a module where feeds or updates are published to certain branches of the user's network.

FIG. 14 depicts an example of a computer system 1400 on which techniques described in this paper can be implemented. The computer system 1400 may be a conventional computer system that can be used as a client computer system, such as a wireless client or a workstation, or a server computer system. The computer system 1400 includes a computer 1402, I/O devices 1404, and a display device 1406. The computer 1402 includes a processor 1408, a communications interface 1410, memory 1412, display controller 1414, non-volatile storage 1416, and I/O controller 1418. The computer 1402 may be coupled to or include the I/O devices 1404 and display device 1406.

The computer 1402 interfaces to external systems through the communications interface 1410, which may include a modem or network interface. It will be appreciated that the communications interface 1410 can be considered to be part of the computer system 1400 or a part of the computer 1402. The communications interface 1410 can be an analog modem, ISDN modem, cable modem, token ring interface, satellite transmission interface (e.g. “direct PC”), or other interfaces for coupling a computer system to other computer systems.

The processor 1408 may be, for example, a conventional microprocessor such as an Intel Pentium microprocessor or Motorola power PC microprocessor. The memory 1412 is coupled to the processor 1408 by a bus 1470. The memory 1412 can be Dynamic Random Access Memory (DRAM) and can also include Static RAM (SRAM). The bus 1470 couples the processor 1408 to the memory 1412, also to the non-volatile storage 1416, to the display controller 1414, and to the I/O controller 1418.

The I/O devices 1404 can include a keyboard, disk drives, printers, a scanner, and other input and output devices, including a mouse or other pointing device. The display controller 1414 may control in the conventional manner a display on the display device 1406, which can be, for example, a cathode ray tube (CRT) or liquid crystal display (LCD). The display controller 1414 and the I/O controller 1418 can be implemented with conventional well known technology.

The non-volatile storage 1416 is often a magnetic hard disk, an optical disk, or another form of storage for large amounts of data. Some of this data is often written, by a direct memory access process, into memory 1412 during execution of software in the computer 1402. One of skill in the art will immediately recognize that the terms “machine-readable medium” or “computer-readable medium” includes any type of storage device that is accessible by the processor 1408 and also encompasses a carrier wave that encodes a data signal.

The computer system 1400 is one example of many possible computer systems which have different architectures. For example, personal computers based on an Intel microprocessor often have multiple buses, one of which can be an I/O bus for the peripherals and one that directly connects the processor 1408 and the memory 1412 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 1412 for execution by the processor 1408. A Web TV system, which is known in the art, is also considered to be a computer system, but it may lack some of the features shown in FIG. 14, such as certain input or output devices. A typical computer system will usually include at least a processor, memory, and a bus coupling the memory to the processor.

In addition, the computer system 1400 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 1416 and causes the processor 1408 to execute the various acts required by the operating system to input and output data and to store data in memory, including storing files on the non-volatile storage 1416.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

Although the foregoing embodiments have been described in some detail for purposes of clarity of understanding, the invention is not limited to the details provided. There are many alternative ways of implementing the invention. The disclosed embodiments are illustrative and not restrictive.

We claim:

1. A system comprising:
a dynamic social network server engine;
a dynamic social network datastore coupled to the dynamic social network server engine;
an analytics engine coupled to the dynamic social network datastore;
a connections view engine coupled to the dynamic social networking server engine.

2. A system comprising:
a user registration and login management engine;
a user profile management engine;
a contact profile specification engine;
a geo-location neighbor discovery engine;
a neighbor filtering and display engine;
a neighbor communication engine;
a neighbor data management engine;
a connections display engine.

3. A method comprising:
obtaining profile information from a member;
discovering neighbors that match the profile information;
displaying neighbor profiles for the member;
receiving an indication of a desire to add a neighbor associated with one of the neighbor profiles to a social networking context of the member;
adding the neighbor to the social networking context of the member.
